(19) United States
(12) Patent Application Publication
(10) Pub. No.: US 2007/0242751 A1
(43) Pub. Date: Oct. 18, 2007

(54) MOVING PICTURE DECODING DEVICE AND MOVING PICTURE GENERATING DEVICE

(75) Inventor: Koji Kitayama, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/733,944

(22) Filed: Apr. 11, 2007

(30) Foreign Application Priority Data
Apr. 14, 2006 (JP) 2006-112500

(51) Int. Cl. H04N 11/02; H04N 11/04

(52) U.S. Cl. 375/240.16; 375/240.18

(57) ABSTRACT

A decoding section generates decoded data from image data that is coded by using N×N orthogonal transform bases on image data of moving picture in pixel number blocks that are divided into N in horizontal and vertical directions. An inverse orthogonal transforming section performs inverse orthogonal transform processing on Nx×Ny pieces of decoded data generated by a decoded data generating section by using Nx×Ny inverse orthogonal transform bases corresponding to the low frequency side in association with downsizing scaling factors Nx/N, Ny/N in the horizontal and vertical directions to generate downsized image data. A position correction section performs position correction on a motion vector that represents a relative position of difference image data, if downsized image data is the difference image data corresponding to a difference from the downsized image data at a different time.

### CROSS-REFERENCE TO RELATED APPLICATIONS

This application is based upon and claims the benefit of priority from the prior Japanese Patent Application No. 2006-112500 filed on Apr. 14, 2006: the entire contents of which are incorporated herein by reference.

### BACKGROUND OF THE INVENTION

1. Field of the Invention

The present invention relates to a moving picture decoding device and moving picture generating device configured to downsize and decode moving picture.

2. Description of the Related Art

If compressed moving picture is played and the image is downsized to match the number of displayed pixels of a display device, a conventional moving picture decoding device performs decoding processing of decoding the compressed moving picture and downsizing processing of decoded moving picture data separately. The conventional case requires a storage for decoding moving picture and a storage for downsizing an image.

Therefore, Japanese Patent Laid-Open No. 2004-129160 as a first antecedent discloses that image data is downsized in such a way that high frequency components at a predetermined frequency or more is removed from a coding stream that is subjected to variable length coding.

In Japanese Patent Laid-Open No. 2004-129160 discloses downsizing processing by which a downsizing processing section of a variable length decoding section removes frequency components at a predetermined frequency or more from a DCT (discrete cosine transform) coefficient that is decoded and quantized by the variable length decoding section.

The antecedent of Japanese Patent Laid-Open No. 2004-129160 does not disclose detailed configuration and operations to downsize an actual image nor suggests means and a method for removing an aliasing noise that occurs when an image is downsized.

Japanese Patent Laid-Open No. 2001-359104 as a second antecedent discloses a converting method for downsizing an image size in the description on a trans-coding device in the publication in more detail than in Japanese Patent Laid-Open No. 2004-129160. The description of trans-coding device discloses a method for suppressing the aliasing noise and downsizing the image.

The device in Japanese Patent Laid-Open No. 2001-359104 does not correct physical relationship with the image that has not been downsized, when an image involving motion compensation by using a motion vector is downsized.

### SUMMARY OF THE INVENTION

A moving picture decoding device according to an embodiment of the present invention includes:

a decoding section configured to decode against coding on image data that is coded after an orthogonal transform processing on pixel number blocks that are the image data forming each screen of moving picture divided into a predetermined number N in horizontal and vertical directions by using N×N two dimensional orthogonal transform bases with space frequencies that are different from each other for the predetermined N in the horizontal and vertical directions;

a decoded data generating section configured to generate Nx×Ny pieces of decoded data that is to be at a low frequency side from a direct current component in the decoded data obtained by the decoding in association with downsizing scaling factors Nx/N, Ny/N in the horizontal and vertical directions (Nx and Ny are natural numbers less than N except 1, respectively);

an inverse orthogonal transforming section configured to perform decoding by inverse orthogonal transform processing on Nx×Ny pieces of decoded data generated by the decoded data generating section by using Nx×Ny two dimensional inverse orthogonal transform bases corresponding to the low frequency side; and

a position correction section configured to perform position correction on a motion vector that represents a relative position of difference image data if downsized image data obtained by the inverse orthogonal transform processing is the difference image data corresponding to a downsized amount of difference obtained at a different time.

A moving picture generating device according to an embodiment of the present invention includes:

a coding section configured to generate coded image data after subjected to orthogonal transform processing on pixel number blocks that are image data forming each screen of moving picture divided into a predetermined number N in horizontal and vertical directions by using N×N two dimensional orthogonal transform bases with space frequencies that are different from each other for the number of the predetermined number N in the horizontal and vertical directions;

a decoding section configured to perform decoding against the coding on said coded image data;

a decoded data generating section configured to generate Nx×Ny pieces of decoded data that is to be at a low frequency side from a direct current component in the decoded data obtained by the decoding in association with downsizing scaling factors Nx/N, Ny/N in the horizontal and vertical directions (Nx and Ny are natural numbers less than N except 1, respectively);

an inverse orthogonal transforming section configured to perform decoding by inverse orthogonal transform processing on Nx×Ny pieces of decoded data generated by the decoded data generating section by using Nx×Ny two dimensional inverse orthogonal transform bases corresponding to the low frequency side; and

a position correction section configured to perform position correction on a motion vector that represents a relative position of difference image data, if downsized image data obtained by the inverse orthogonal transform processing is the difference image data corresponding to a downsized amount of difference obtained at different time.

### BRIEF DESCRIPTION OF THE DRAWINGS

FIG. 1 is a configuration diagram showing a moving picture generating display device according to a first embodiment of the present invention;

FIG. 2 is a block diagram showing a configuration of a compressed image generating section;

FIG. 3 is a diagram showing a configuration of a decoding device with an image downsizing function;

FIG. 4 is a diagram showing a processing configuration for an image of an intra picture in FIG. 3;

FIG. 5 is a diagram showing a processing configuration for an image of an inter picture in FIG. 3;

FIG. 6 is a diagram showing a matrix of 4×4 coefficients generated by the orthogonal transform correction section by relationship between the matrix and a matrix of 8×8 coefficients;

FIG. 7 is an illustration of the processing of correcting by a coordinate correction section;

FIG. 8 is a diagram showing relationship of a pixel position in a normal image coordinate system before downsizing and the downsized image coordinate system that is downsized to ½ in the horizontal and vertical directions;

FIG. 9 is a diagram showing relationship of a pixel position in a normal image coordinate system before downsizing and the downsized image coordinate system that is downsized to ⅜ in the horizontal and vertical directions in a second embodiment of the present invention; and

FIG. 10 is a diagram showing relationship of a pixel position in the horizontal direction, for example, in a normal coordinate system and a pixel position downsized to ½, ⅓ and ¼.

### DETAILED DESCRIPTION OF THE PREFERRED EMBODIMENTS

Embodiments of the present invention will be described with reference to the drawings.

### First Embodiment

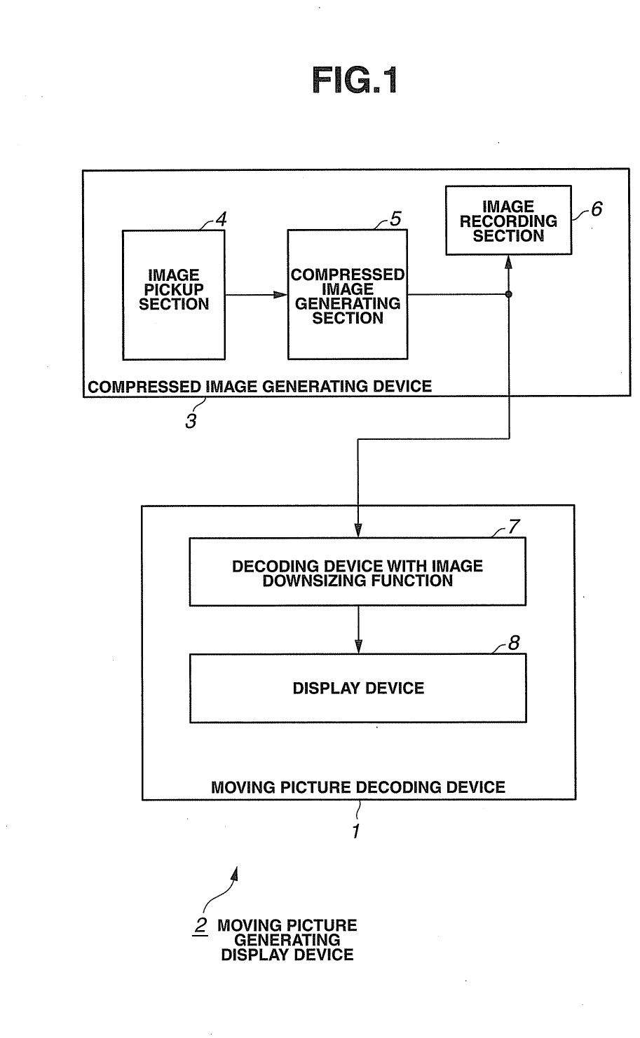

FIG. 1 shows a moving picture generating displaying device 2 with a moving picture decoding device 1 having an image downsizing function according to a first embodiment of the present invention.

The moving picture generating displaying device 2 includes a moving picture compressing device 3 configured to generate compressed and decoded moving picture and a moving picture decoding device 1 with an image downsizing function for decoding image data of compressed and coded moving picture and displaying a downsized image.

The moving picture compressing device 3 includes an image pickup section 4 configured to capture moving picture, for example, a compressed image generating section 5 configured to compress and code a captured moving picture (as a coding section), a hard disk configured to store a compressed and coded moving image data, and an image recording section 6 such as a DVD-RAM and the like. The compressed image generating section 5 compresses and codes moving picture by using motion compensation by MPEG-4, for example.

The image compressed and coded by MPEG-4 that is generated by the compressed image generating section 5 is decoded by a decoding device connected to a normal display device without downsizing the display size so that the decoded image can be displayed on the display device.

If the image captured by the image pickup section 4, for example, is compressed and coded and to be viewed on a monitor, a display device of a small display size (the number of pixels for display), for example, is used.

The moving picture decoding device 1 according to the first embodiment is, as described above, suitable for displaying an image on a display device with a less number of pixels for display than the normal display size. Although the present embodiment is described by a case where an image is displayed on a display device, the embodiment can also be applied to a case where an image is printed by a moving picture printer.

The moving picture decoding device 1 includes a decoding device with a compressed image downsizing function 7 into which image data of moving picture that is compressed, coded and output from the compressed image generating device 5 and a display device 8 on which a decoded downsized image output from the decoding device with a compressed image downsizing function 7.

In the configuration shown in FIG. 1, the side of the moving picture compressing device 3 may have a modulator configured to modulate an image of MPEG-4 generated by the compressed image generating section 5 and transmitting the image by a radio wave, and the side of the moving picture decoding device 1 may have a decoder. The moving picture decoding device 1 may have a function of a portable moving picture decoding device configured to demodulate a signal modulated by the modulator.

The compressed image generating section 5 will be described in the case where moving picture is compressed by MPEG-4, for example, in the description below. The decoding device with a downsizing function 7 will be described by the case where an image is downsized by the function of ½ (¼ for the number of pixels size) in the horizontal and vertical directions and displayed on the display device 8.

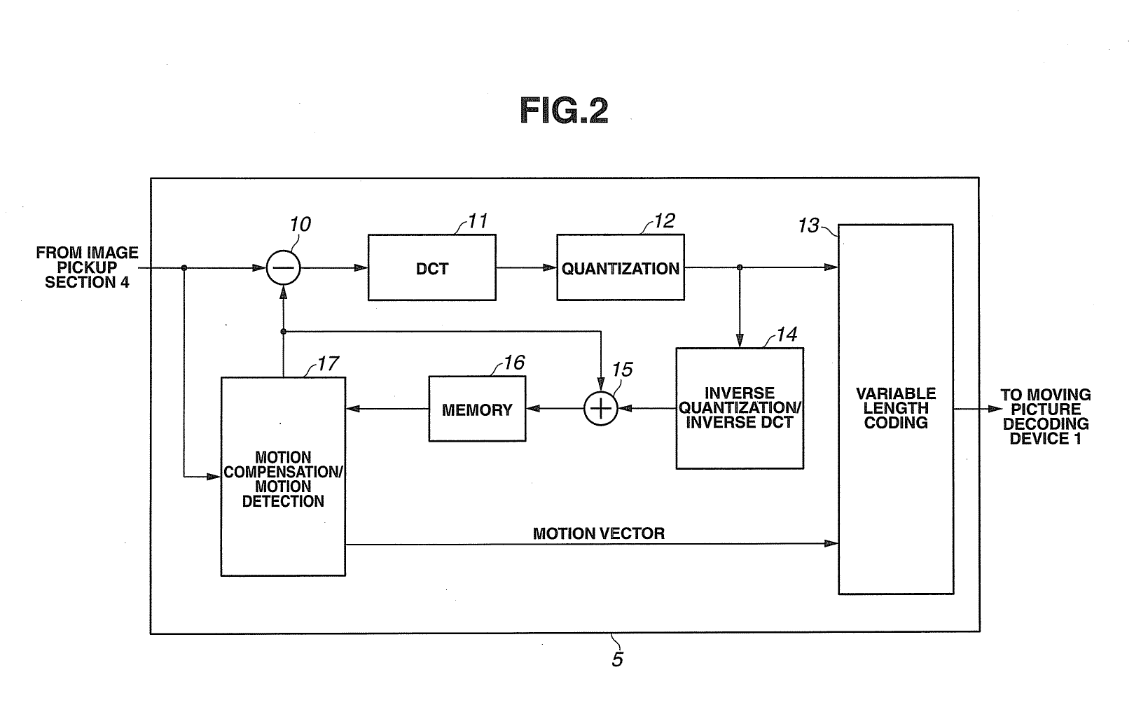

As shown in FIG. 2, an input image of a screen called a moving picture object plane (abbreviated to VOP) of moving picture captured by the image pickup section 4 of the moving picture camera and subjected to A/D conversion, for example, passes through a subtracter 10 and inputted to a discrete cosine conversion section 11 (abbreviated to DCT) that codes image compression. Occurrence of the aliasing noise is suppressed in the image captured by the image pickup section 4 by a low pass filter or the like before being subjected to the A/D conversion (abbreviated to DCT).

In the DCT section 11, image data of a screen is divided into blocks by a predetermined number of pixels in the horizontal and vertical directions. The DCT section 11 performs the two dimensional DCT processing on image data in each block by using a DCT base that will be the orthogonal transform base for the space frequency in the horizontal and vertical directions in association with the number of pixels in the horizontal and vertical directions in each block.

In the case where the numbers of pixels in the horizontal and vertical directions in each block are N (=8) respectively and information on the number of pixels of the two dimensional coordinate (x, y) in the horizontal and vertical directions is f(x,y), the DCT coefficient F(u,v) of the coordinate (u, v) on a frequency axis is represented as
F(u,v)=2c(u)c(v)/(N)ΣₓΣ_{y}f(x,y)cos((2x+1)uπ/(2N)cos((2y+1)vπ/(2N)) (1).

c(u), c(v)=½-½: if u, v=0,

c(u), c(v)=1: if u=1,2, . . . N-1, v=1,2 . . . , N-1

Here, Σₓ represents the total of x=0 to x=N-1, Σ_{y} represents the total of y=0 to y N-1.

DCT coefficient F(u,v) data as image data that is subjected to the DCT processing and coded is quantized at the quantizing section 12. The quantized DCT coefficient and the quantizing width are inputted into the variable length coding section 13 and coded into a variable length at the variable length coding section 13. The coding is called an intra coding. The VOP that is subjected to the intra coding is called I-VOP or an intra picture.

The converting coefficient quantized by the quantizing section 12 is subjected to the inverse quantization and the inverse DCT processing at the inverse quantization/inverse DCT section 14. The output from the inverse quantization/inverse DCT section 14 and the output from a motion compensation/motion detecting section 17 to be described later are added and subtracted by an adder 15 and stored in a memory 16.

The motion compensation/motion detecting section 17 compares the image data to be inputted and a reference image stored in the memory 16 to detect a motion vector indicating a relative displacement against the reference image and outputs the obtained motion vector data to the variable length coding section 13.

The motion compensation/motion detecting section 17 performs predictive compensation according to detected result of the motion vector and outputs the predicted image data to a subtracter 10. From the subtracter 10, a predicted difference image that is a difference between the input image and a predicted image for which motion compensation is predicted is input in the DCT section 11. The DCT section 11 performs the DCT processing and the quantization section 12 quantizes. The variable length coding section 13 performs the variable length coding on the quantized DCT coefficient with the motion vector and the quantized width. The image data subjected to the variable length coding is called the inter-picture subjected to the inter coding.

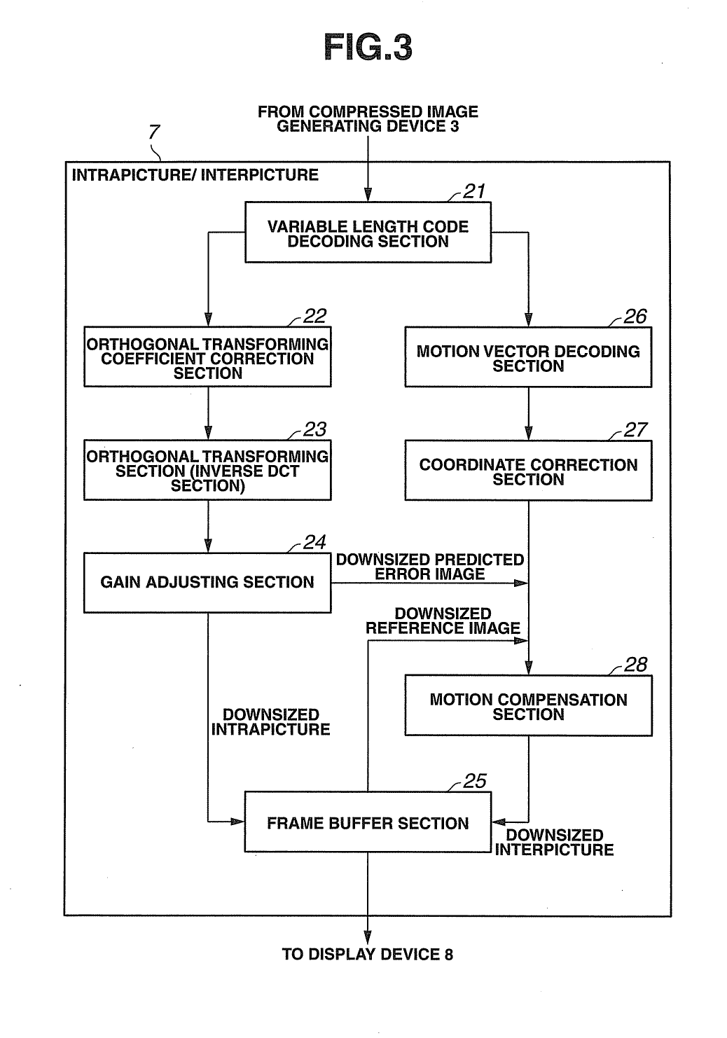

The image data compressed and coded by MPEG-4 that is outputted from the compressed image generating section 5 is inputted in the decoding device with an image downsizing function 7 shown in FIG. 3 forming the moving picture decoding device 1.

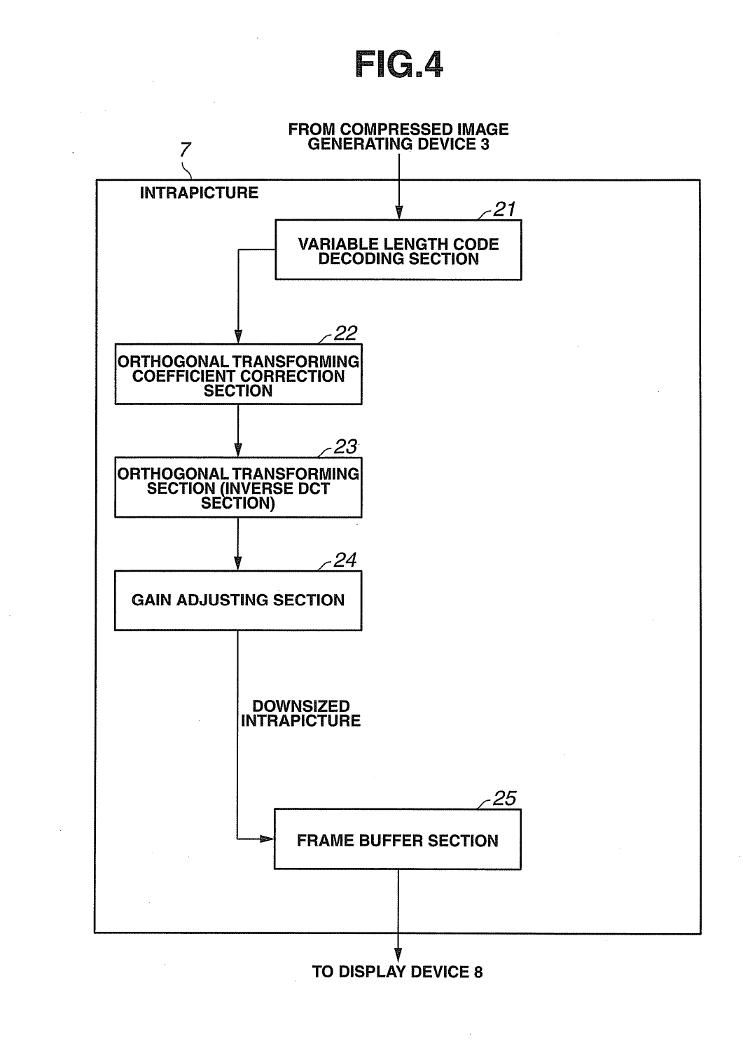

For an image of an intra-picture, some components of the decoding device with an image downsizing function 7 of FIG. 3 are used as shown in FIG. 4. The configuration and the processing in the case where an intra-picture is inputted will be described with reference to FIG. 4, and then the configuration and the operation will be described in the case where an image of the inter-picture is inputted.

The image data of the intra-picture is inputted in the variable length code decoding section 21 as a decoding section. The variable length code decoding section 21 interprets the data in MPEG-4 and performs decoding processing on the variable length code. The variable length code decoding section 21 sends the orthogonal transform coefficient data that is subjected to the orthogonal transform as decoded data obtained at the decoding processing to the orthogonal transform coefficient correction section 22.

The orthogonal transform coefficient correction section 22 corrects the decoded orthogonal transform coefficient data to orthogonal transform coefficient data in association with image downsizing and outputs the corrected orthogonal transform coefficient data to an orthogonal transforming section (specifically, the inverse DCT section) 23.

The corrected orthogonal transform coefficient data becomes (N/2)×(N/2) pieces of decoded data in association with a downsizing rate, if the number of pieces of the decoded data before compression is N×N.

The orthogonal transform coefficient data is also called a coefficient matrix or coefficient data as it is processed by a plurality of two dimensional data when it is subjected to the inverse DCT processing.

The orthogonal transforming section 23 is formed by the inverse DCT section that performs the inverse DCT processing in association with coding at the DCT section 11 used in the abovementioned compressed image generating device 5. That is to say, the orthogonal transforming section 23 has a function of the inverse orthogonal transform processing section that performs the inverse orthogonal transform processing that is an inverse transforming processing (or a decoding processing) against the orthogonal transform processing by the orthogonal transforming section in coding.

If the orthogonal transforming section 23 does not perform image downsizing, the orthogonal transforming section 23 converts an image into a decoded image or a motion predicted difference image (difference image) by performing the two dimensional inverse DCT by 8×8 that is defined in the MPEG-4 standard.

The decoding device with downsizing function 7 in the present embodiment generates a downsized image that is downsized by ½ in the horizontal and vertical direction (length-width) respectively. For that purpose, the orthogonal transform coefficient correction section 22 generates only a matrix of 4×4 coefficients with a high frequency components removed in a matrix of 8×8 coefficients, and sends the 4×4 pieces of coefficient data to the orthogonal transforming section 23 as decoded data (with ½ downsizing rate in the horizontal and vertical directions respectively). As described above, the orthogonal transform coefficient correction section 22 has a function of decoded data generating section configured to generate decoded data for generating a downsized image.

The orthogonal transforming section 23 performs the two dimensional inverse DCT processing on coefficient data by using the 4×4 inverse DCT bases corresponding to the low frequency side in association with the 4×4 pieces of coefficient data. The processing gives the same result as the two dimensional inverse DCT processing is performed on data by using 8×8 inverse DCT bases and then passed through the low pass filter in which the cutoff frequency is ½ of the maximum frequency in the DCT bases that is the maximum frequency in the horizontal and vertical directions, and downsized to ½ in the horizontal and vertical directions, respectively.

The present embodiment performs the inverse DCT processing by using only 4×4 pieces of coefficient data with the high frequency components removed, while the orthogonal transforming section 23 also uses 4×4 two dimensional inverse DCT bases with the high frequency components removed. The processing can significantly reduce the calculation amount compared with the case where 8×8 inverse DCT bases are used and also prevent an aliasing noise from occurring only by the inverse DCT processing eliminating the low pass filter processing.

The present embodiment performs the inverse DCT processing by using 4×4 two dimensional inverse DCT bases corresponding to 4×4 DCT bases at the two dimensional low frequency side. Accordingly, the inverse DCT processing result reflecting a feature part on which statistically energy converged at the low frequency side (having bigger amplification) compared to the case where the inverse DCT processing by using 4×4 inverse DCT bases that are formed by thinning 8×8 bases in the second antecedent. Therefore, a downsized image with good S/N can be generated.

A calculation result of the inverse DCT processing by the orthogonal transforming section 23 is sent to the gain adjusting section (or a scale correction section) 24. The inverse DCT processed coefficients become values that are the downsizing scaling factors are multiplied by √2 (from the two dimensional viewpoint, multiplied with ½) in the horizontal and vertical directions respectively. Therefore, the gain adjusting section 24 multiplies each coefficient by 1/√2, performs scale correction on it and generates the downsized image. The downsized image is stored in the frame buffer section 25.

If the downsized image stored in the frame buffer section 25 is the intra picture, it is outputted to the side of the display device 8. An image of the intra picture stored in the frame buffer section 25 is used as a reference image to generate an inter picture when motion compensation is performed at the motion compensation section 28 to be described later.

In that case, the coordinate correction section 26 performs the position correction of the motion vector in the present embodiment. That is to say, if the downsized image of the inter picture is generated by adding the downsized predicted error difference image (difference image), which is to be a difference, to the downsized image (reference image) of the intra picture in different frame, the coordinate correction section 26 generates the downsized image with a little displacement.

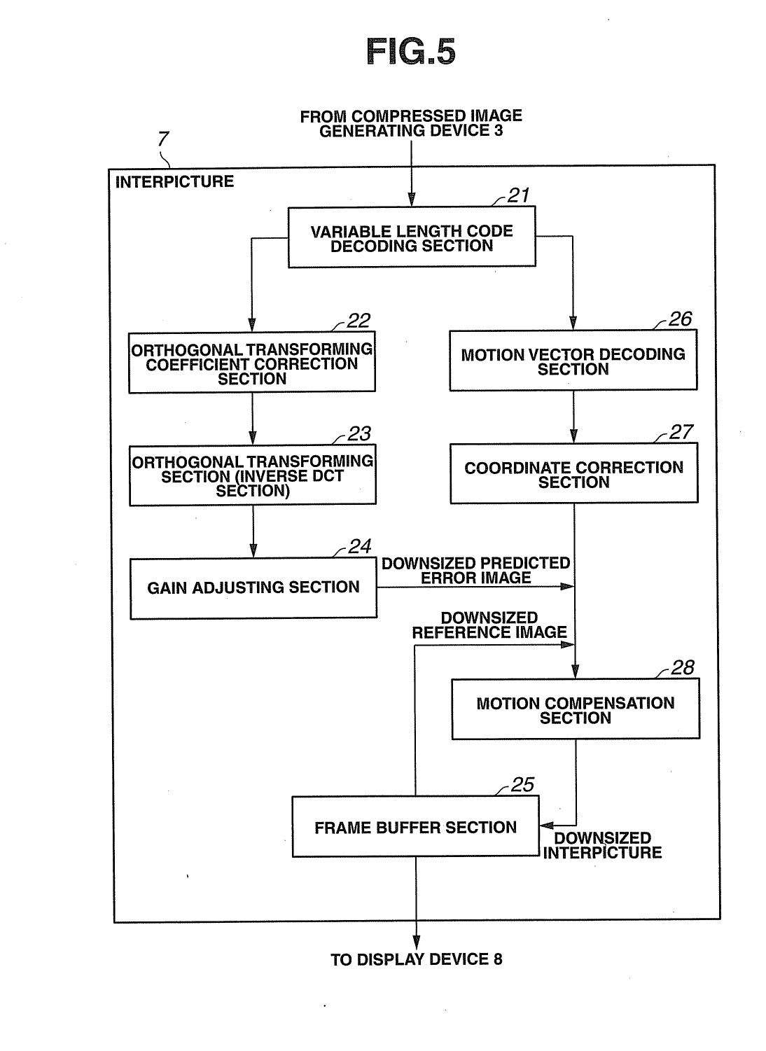

Now, a case of the inter picture will be described with reference to FIG. 3 or FIG. 5. FIG. 5 shows processing of the decoding device with an image downsizing function 7 when the inter picture is inputted.

The input image of the inter picture is inputted in the variable length code decoding section 21 and is processed similarly to the case of the input image of the intra picture from the variable length code decoding section 21 through the orthogonal transform coefficient correction section 22, the orthogonal transforming section 23 and the gain adjusting section 24. In this case, the downscaled predicted error image outputted from the gain adjusting section 24 is sent to the motion compensation section 28.

The variable length code decoding section 21 extracts a data part of the motion vector indicating relative displacement from an image of the intra picture in the predicted difference image before downscaling from the image data to be inputted and sends it to a motion vector decoding section 26.

The data part includes (an endpoint of) the motion vector and a macroblock number to be described later, with a starting point of the motion vector is defined as a point on the upper left corner in each macroblock.

The motion vector decoding section 26 calculates the position of a pixel referenced in the motion compensation processing from the inputted motion vector (and the macroblock number).

The motion vector decoding section 26 sends information on the calculated position to the coordinate correction section 27. The coordinate correction section 27 corrects the pixel position that is sent for reference to the downsized coordinate system. Then, the coordinate correction section 27 sends information on the motion vector for the corrected pixel position to the motion compensation section 28.

The motion compensation section 28 performs the processing of adding the predicted difference image downsized at the pixel position, which is the corrected position of the motion vector, to the downsized reference image in accordance with the motion vector corresponding to the downsized image and the coordinate system of the downsized reference image saved in the frame buffer section 25. Then, the motion compensation section 28 generates an image of the downsized inter picture by the addition processing and stores the image in the frame buffer section 25. The downsized inter picture image is outputted from the frame buffer section 25 to the display device 8.

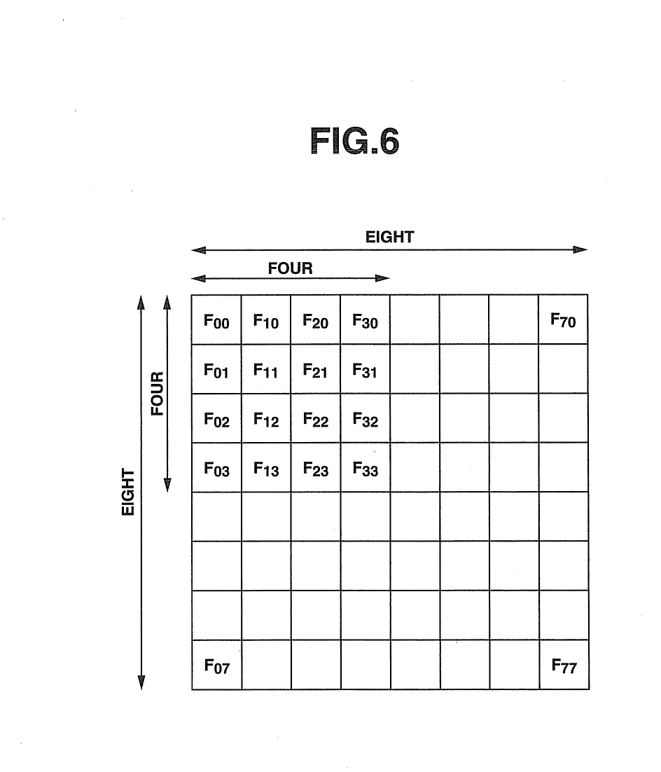

FIG. 6 shows coefficient data of a matrix of 4×4 coefficients generated by the orthogonal transform coefficient correction section 22. If the decoding processing without involving downsizing of the image is performed, the orthogonal transform coefficient correction section 22 uses a matrix of 8×8 coefficients in the horizontal and vertical directions as shown in FIG. 6. In the present embodiment, only a matrix of 4×4 coefficients (coefficient data parts indicated by F00-F30, F01-F31, F02-F32, F03-F33) at the low frequency side with the high frequency components removed is used for performing the decoding processing involving the image downsizing.

FIG. 6 shows some coefficient data F70 corresponding to the maximum frequency components in the horizontal direction, some coefficient data F70 corresponding to the maximum frequency components in the vertical direction and coefficient data corresponding to the maximum frequency components in the horizontal and vertical directions for description.

Then, the orthogonal transform coefficient correction section 22 sends the 4×4 pieces of coefficient data to the orthogonal transforming section 23. The orthogonal transforming section 23 performs the inverse DCT conversion only with 4×4 inverse DCT bases corresponding to the 4×4 pieces of coefficient data at the low frequency side by using the 4×4 pieces of coefficient data. Assuming the pixel value in the horizontal or vertical directions in the 4×4 blocks f (x, y), the inverse DCT processing is represented as
f(x,y)=(½)ΣᵤΣᵥc(u)c(v)F(u,v)cos((2x+1)uπ/8)cos((2y+1)vπ/8) (2).
Here,

c(u), c(v)=½-½, if u,v=0,

c(u), c(v)=1, if u=1,2, . . . 3v=1,2, . . . 3.

Σᵤ represents the total from u=0 to x=3, Σᵥ represents the total from y=0 to y=3. The F00 difference and the like shown in FIG. 6 corresponds to the F(0,0) or the like in the expression (2).

In this manner, the inverse DCT processing by the orthogonal transforming section 23 can provide the downsized image data downsized from the original 8×8 pieces of image data to 4×4 pieces of data. In this case, as the number of pieces of the coefficient data and the number of the inverse DCT bases can be reduced to ¼ respectively, the calculation amount in the inverse DCT processing by the orthogonal transforming section 23 is significantly reduced. Thus, the present embodiment can generate the downsized image in a short time.

In the embodiment, the orthogonal transforming section 23 performs the inverse DCT processing with 4×4 pieces of coefficient data at the low frequency side and 4×4 inverse DCT bases at the low frequency side corresponding to the 4×4 pieces of coefficient data at the low frequency side.

Accordingly, the orthogonal transforming section 23 easily removes the aliasing noise that can occur when the inverse DCT processing is performed with the coefficient data corresponding to the higher frequency than the 4×4 inverse DCT bases at the low frequency side.

For example, a downsized image can be generated with the inverse DCT processing by using 8×8 pieces of coefficient data and tinning the images generated thereafter. In such a case, an aliasing noise can be mixed into the downsized image. If the coefficient data that does not correspond to the downsizing scaling factor is selected even if some pieces of coefficient data at the low frequency side are used instead of selecting and using the coefficient data to the number corresponding to the downsizing scaling factor of the image in order from the low frequency side components (to the high frequency component side) as in the present embodiment, the aliasing noise may be also mixed into the downsized image resulting in the degraded image.

In the present embodiment, the coefficient data from the maximum frequency at the DCT base before downsizing to the frequency components higher than ½ of the maximum frequency are not used as the numbers of the pixels are reduced to ½ in the horizontal and vertical directions respectively. That is to say, as the present embodiment uses only the inverse DCT bases corresponding to the DCT bases with ½ of the maximum frequency from the direct current components and the coefficient data at the corresponding low frequency side, it eliminates the possibility that the aliasing noise is mixed in the downsized image.

In this manner, the image that is downsized by the 4×4 inverse DCT processing (against the existing 8×8 inverse DCT processing) is sent to the gain adjusting section (scale correction section) 24 from the orthogonal transforming section 23.

As the coefficients subjected to the inverse DCT processing are the values that the downsizing scaling factors are multiplied by √2 in the horizontal and vertical directions, the gain adjusting section 24 performs the scale correction by multiplying each coefficient by 1√2 and generates the downsized image with a correctly resumed brightness level. In the case of the intra picture, the downsized image is sent to the frame buffer section 25 without performing the motion compensation.

The frame buffer section 25 keeps the downsized image in order to use the downsized image as a reference image of the inter picture and outputs the downsized image to the display device 8. Then, the downsized image with good image quality is displayed on the display device 8 without any aliasing noise mixed.

Now, a case of an inter picture as difference image data at a time different from the reference image will be described.

The variable length code decoding section 21 sends the motion vector to the motion vector decoding section 26. The motion vector decoding section 26 calculates the position of the pixel referenced by the motion vector in the motion compensation processing and sends the calculated position of the pixel to the coordinate correction section 27.

In this case, two pieces of data of the motion vector and the macroblock number are inputted in the motion vector decoding section 26.

The motion vector is the value decoded in the variable length code decoding section 21, represented by two relative values in the directions of x and y. The macroblock number is the number of the macroblock being decoded.

The absolute position of the pixel block to be decoded (64 pixels of 8×8) can be obtained from the data of the macroblock number and the motion vector indicated by the macroblock. In such a case, the motion vector is the data indicating the end point (two dimensional position) in the macroblock with the upper left of each macroblock as a starting point.

The motion vector decoding section 26 calculates the pixel position to be referenced that is used in the motion compensation processing by using the macroblock number and the motion vector. Here, the case where the size of an image is 176 pixels in the horizontal direction and 144 pixels in the vertical direction is considered as an example.

The 176×144 image is 11 in the horizontal direction and 9 in the vertical direction for each macroblock. If the macroblock number to be inputted to the motion vector decoding section 26 is 12 counted from 0 in the order of raster scanning, the upper left pixel position of the macroblock is calculated as x=16×1=16. y=16×1=16 to be (16, 16).

The motion vector decoding section 26 calculates the pixel position to be referenced by adding the value of the motion vector to the value (16, 16). If the motion vector is (−2, −1), the motion vector decoding section 26 calculates the pixel position to be referenced as (14, 15). The motion vector (−2, −1) and the like described here is merely an example, represented by the unit of integer pixel unit for simple understanding.

The actual data is represented either by the unit of half Pel (½ pixel) or by the unit of quarter Pel (¼ pixel). The pixel position to be referenced that is calculated in this manner is processed in correspondence with the downsized image at the coordinate correction section 27.

The orthogonal transform coefficient data obtained at the variable length code decoding section 21 is sent to the orthogonal transform coefficient correction section 22. The orthogonal transform coefficient value is processed in the same manner as in the case of the intra picture, and then the predicted difference image is generated through the orthogonal transforming section 23 and the gain adjusting section 24.

The coordinate correction section 27 corrects the pixel position to be referenced that is sent from the motion vector decoding section 26 into the downsized coordinate system that is after downsizing and outputs it to the motion compensation section 28. The motion compensation section 28 generates the downsized inter picture by using the corrected motion vector and the downsized reference image kept in the frame buffer section 25.

The downsized image of the inter picture that is downsized in the manner is sent to the frame buffer section 25. The frame buffer section 25 outputs the downsized image of the inter picture to the display device 8. The display device 8 displays the downsized image.

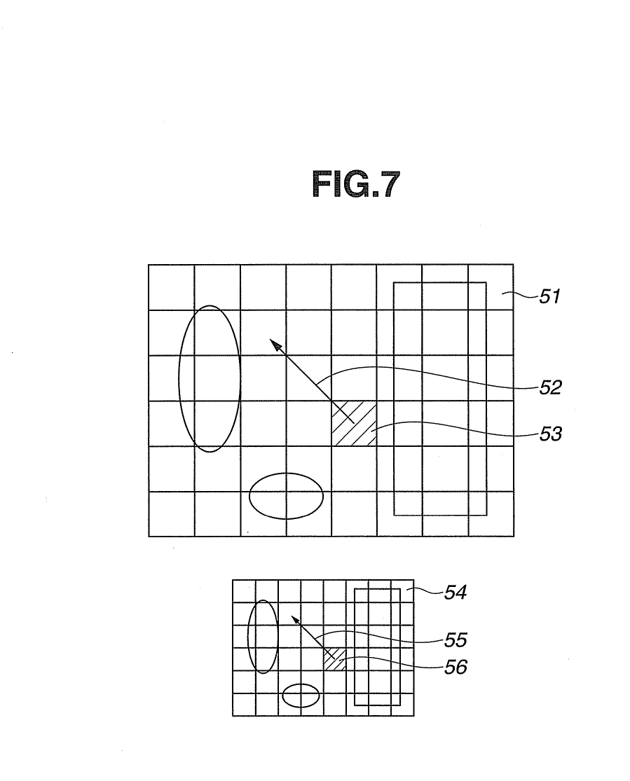

FIG. 7 is a schematic diagram showing the case where the coordinate correction section 27 corrects the motion vector 52 included in a small region 53 of the image 51 that is not downsized. The coordinate correction section 27 corrects the motion vector to the motion vector 55 included in a small region 56 of the downsized image 54 shown in the lower side of FIG. 7.

The coordinate correction section 27 converts the value of the coordinate of the motion vector in the image that is not downsized taking account of displacement of the center of the image according to the downsizing scaling factor of the reference image stored in the frame buffer section 25. In this example of downsizing, the coordinate correction section 27 first corrects the size of the motion vector before downsizing to the sizes of ½ in the horizontal and vertical directions respectively.

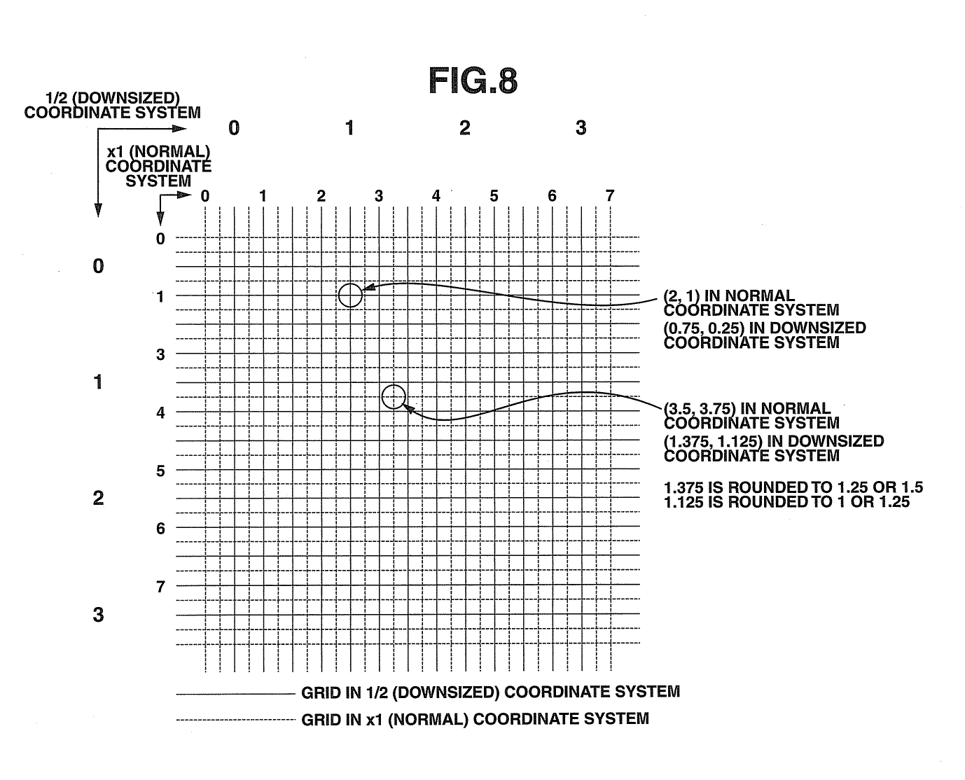

FIG. 8 shows relationship of pixel positions to be referenced in the motion compensation processing in the downsized image system in which the normal image before downsizing (original image) is downsized by ½ in the horizontal and vertical directions.

The representation of FIG. 8 shows to the quarter Pel position. In this case, the dashed line shows grid in the normal coordinate system of the normal image before downsizing. Meanwhile, the solid line shows grid in the downsized coordinate system after downsized by ½. Downsizing of the image may mean taking wider (relatively compared to the case it is not downsized) distance for sampling a pixel, thus, the grid distance after downsizing becomes wider.

With the downsizing processing performed on the image, the sample center of the pixel is displaced. The pixel in the coordinate (0, 0) of the normal image and the pixel in the coordinate (0,0) of the downsized image indicate different positions in the real space by taking consideration of the displacement.

This is because performing the inverse DCT processing with the high frequency side components removed corresponds to the processing of thinning pixels through the low pass filter as mentioned above as a result. Accordingly, the pixel position of the downsized coordinate system is displaced toward the center.

Thus, the embodiment not only generates the motion vector for the downsized image by simply scaling down (downsizing) the value of the motion vector in the horizontal and vertical direction by ½ but also corrects the pixel position of the motion vector in the normal coordinate system by (0.25, 0.25) in the horizontal and vertical directions so as to adjust the pixel position in the downsized coordinate system.

That is to say, the present embodiment generates the motion vector corresponding to the downsized predicted difference image by downsizing the motion vector in the normal coordinate system as a motion vector corresponding to the image before downsizing the predicted difference image that is obtained as it is downsized by ½ downsizing scaling factor. The position of the generated motion vector is further corrected in the horizontal and vertical directions by the values corresponding to the ½ downsizing scaling factor.

The present embodiment performs correction corresponding to the pixel position to be referenced more precisely by performing position correction toward the center position in such a manner. The present embodiment can perform the position correction with a little displacement of the downsized image generated as the reference image and the predicted difference image in different frames are combined by being subjected to the position correction. Thus, the present embodiment has an effect of improving image quality. The position correction will be described in detail below.

Assuming that the pixel position to be referenced that is inputted in the coordinate correction section 27 is (2, 1) when an image is downsized by ½ in the horizontal and vertical directions, respectively.

The integer Pel coordinate axis of the downsized image after downsized by ½ is at the position shifted by ½ in the normal coordinate system. An integer Pel in the normal coordinate system is treated as half Pel in the downsized coordinate system after downsized by ½. Thus, the image position to be referenced in the downsized coordinate system is converted into (0.75, 0.25). Similarly, assuming that the pixel position to be referenced is (3.5, 3.75) in the normal coordinate system, the space point is represented as (1.375, 1.125) in the downsized coordinate system as shown in FIG. 8.

Therefore, the pixel position Pos in the normal coordinate system shown by the motion vector is generalized in the downsized coordinate system that downsizes the image by ½ as below.
Pos′=Pos/2−0.25 (3)

Here, Pos is the pixel position indicated by the motion vector in the normal coordinate system, while Pos′ is the pixel position of the corresponding motion vector in the downsized coordinate system.

If the image is corrected in accordance with the pixel position to be referenced, the pixel position represented in the downsized coordinate system after downsizing is twice as fine as the values in the normal coordinate system. That is to say, in the abovementioned specific example, the position of (3.5, 3.75) in the normal coordinate system is (1.375, 1.125) in the downsized coordinate system.

If the half Pel position (½ pixel position) is indicated in the normal coordinate system, the position indicates the quarter Pel position (¼ pixel position) in the downsized coordinate system. In the MPEG-4 Standard, the pixel can be represented up to the half Pel or the quarter Pel position.

In this case, ⅛ pixel position can be generated at the motion compensation section 28, however, it requires to add a new program and hardware. Thus, it is not preferable.

Accordingly, the present embodiment performs rounding processing to approximate data to make the data complying with the standard so that it can be processed by the MPEG-4 or the like of a predetermined standard in the correction of the motion vector. That enables the case to be achieved in a low cost in a predetermined standard. As described above, the present embodiment performs rounding in the correction of the motion vector so that it can be processed in a predetermined standard, here, the MPEG-4 standard.

If the rounding processing is performed simply as downward rounding or upward rounding, differences are accumulated. In other words, if rounding up or rounding down is performed on data portions that deviate from the standard as the processing for approximating the data to data in a predetermined standard, differences are accumulated.

Accordingly, the present embodiment minimizes accumulated differences by alternating rounding up and rounding down for each picture (frame). The accumulated differences are not to be limited to be minimized and accumulated difference may be reduced to a predetermined value or less.

For example, if the position of (1.375, 1.125) is rounded down on a picture of number m (m is a natural number), the position becomes (1.25, 1.00). In the picture of the next number m+1, the position is rounded up to be (1.50, 1.25). In the present embodiment, the motion compensation section 28 alternates rounding upward and rounding downward for each picture like this.

The rounding may be alternated for each picture or by appropriate time cycles, or for each macroblock or for each appropriate processing region.

The functions of the coordinate correction section 27 and the motion compensation section 28 may be combined to perform position correction and rounding on the motion vector.

In the present embodiment, the rounding processing is appropriately performed for each frame (may be by appropriate time cycles) or for each processing region or the like to restrain accumulation of differences to obtain a downsized image with a good image quality. According to the present embodiment, the processing for generating a downsized image can be processed in a predetermined standard at a lower cost.

Therefore, according to the present embodiment, the inverse DCT processing on an image can provide a downsized image with simple downsizing processing with a little calculation amount, while preventing an aliasing noise from being mixed in downsizing the image.

For an image of the inter picture, position correction can be performed on the motion vector in accordance with the downsized image so that the downsized image with good image quality can be obtained. As a downsized image as generated by the inverse DCT processing, the downsized image in the state where energy is kept focused at the low frequency side by the DCT processing can be obtained.

### Second Embodiment

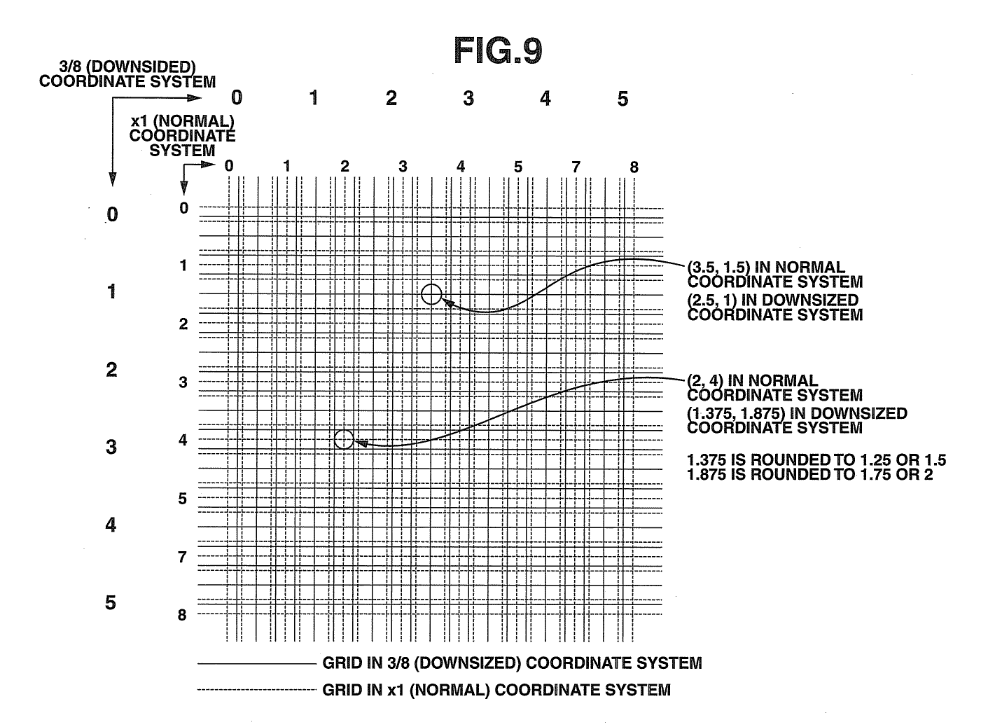

Now, referring to FIG. 9, the moving picture decoding device according to a second embodiment of the present invention will be described. The first embodiment is described by an example of downsizing a normal image by ½ in the horizontal and vertical directions respectively. In contrast, in the second embodiment, moving picture by the MPEG-4 is downsized by Nx/8, Ny/8 in the horizontal and vertical directions respectively and decoded and displayed, for example. Here, Nx and Ny are natural numbers less than eight, respectively.

The configuration of the second embodiment is similar to that of the first embodiment. The block configuration shown from FIG. 1 to FIG. 3 according to the first embodiment is the same as that of the second embodiment, except for a part of processing of the orthogonal transform coefficient correction section 22, the orthogonal transforming section 23, the gain adjusting section 24, the motion vector decoding section 26, the coordinate correction section 27 and the motion compensation section 28 in FIG. 3.

Accordingly, in the second embodiment, only the part different from the first embodiment will be described. The same components as those in the first embodiment are denoted by the same reference numerals.

In the present embodiment, the variable length decoding section 21 (forming a decoding section) performs the same processing as that of the first embodiment. The variable length decoding section 21 sends the orthogonal transform coefficient data obtained by the decoding processing to the orthogonal transform coefficient correction section 22 (as decoded data).

The orthogonal transform coefficient correction section 22 corrects the orthogonal transform coefficient data sent from the variable length decoding section 21 so as to be the coefficient data corresponding to generating a downsized image of Nx/8, Ny/8, and outputs the corrected orthogonal transform coefficient data to the orthogonal transforming section (inverse DCT section) 23 as the inverse orthogonal transforming section.

Assuming the number of pixels corresponding to the downsizing scaling factors Nx/N, Ny/N in the horizontal and vertical directions are Nx, Ny respectively, the inverse DCT converting expression by the inverse DCT section that forms the orthogonal transforming section 23 is represented as
f(x,y)=2/(N×Ny)^{-1/2}ΣᵤΣᵥc(u)c(v)F(u,v)cos((2x+1)uπ/Nx)cos((2y+1)vπ/Ny) (4).
Here,

c(u), c(v)=½-½, if u, v=0

c(u), c(v)=1, if u=1, 2, . . . Nx-1 v=1.2, . . . Ny-1.

In this case, if normal image downsizing is not done, Nx=Ny=8.

In the present embodiment, Nx×Ny pieces of coefficient data that are selected from the low frequency side are used for the coefficient data in downsizing an image by Nx/8, Ny/8 as it is apparent from the above expression (4) instead of using the coefficient data at the high frequency side.

For example, if an image is downsized by ⅜ in the horizontal direction and by 4/8 in the vertical direction, 3×4 pieces of coefficient data are used. Accordingly, 3×4 inverse DCT bases corresponding to coefficient data with low frequency in the horizontal and vertical directions are used.

As described above, by performing the inverse DCT processing corresponding to the downscaling factor as shown in the expression (4), the inverse DCT processing can be performed with simple and a few processes and an aliasing noise can be prevented from being mixed when an image is downsized.

That is to say, as it is apparent from the expression (4), the inverse DCT bases to be used are those corresponding to the bases from the lowest frequency to be a DC component to Nx-1 (in the DCT conversion) and those corresponding to the bases from the lowest frequency to have the frequency 0 (DC component) in the vertical direction to the Ny-1 instead of the inverse DCT bases corresponding to the higher frequency side than the abovementioned DCT bases. Similarly, the coefficient data is also used as those selected from the low frequency side in order.

Thus, the inverse DCT processing prevents an aliasing noise from being occurred and mixed when the image is downsized.

In the present embodiment, the gain adjusting section 24 performs scale correction according to the downsizing scaling factor of the image.

A method for calculating a constant for scaling a coefficient at the gain adjusting section 24 will be described.

If an image is downsized to Nx/8, Ny/8 in the horizontal and vertical directions respectively and a constant term shown in the expression (4) is set to the number of pixels of the downsized image, the constant term is 2/((Nx/8)(Ny/8))^{1/2}. That is to say, the ratio of the constant terms is 2/(8×8) ½÷2/((Nx/8)(Ny/8))^{1/2}=(N×Ny)^{1/2} compared with the case where the 8×8 inverse DCT processing is performed.

That is to say, the constant term shown in the expression (4) is (N×Ny)^{1/2} times the constant in the case where the 8×8 inverse processing is performed. Therefore, the gain adjusting section 24 scales the coefficient with the root value of the inverse numbers of the horizontal and vertical DCT bases. That is to say, the gain adjusting section 24 performs scaling by dividing the constant value subjected to the inverse transforming by (N×Ny)^{1/2}.

The motion vector compensation section 28 generates a downsized image by multiplying the motion vector by (N×Ny)^{1/2}/8 of the downsizing scaling factor, adjusting the magnitude to the downsized image and correcting the position. In this manner, the motion compensation section 28 obtains the downsized inter picture by using the corrected motion vector and the downsized reference image.

FIG. 9 shows relationship between pixel positions of an image that is referenced in the motion compensation processing on the downsized image that is a normal image downsized by ⅜ in the horizontal and vertical directions, for example.

As the center position to represent the pixel displaces as in the case where the image is downsized by ½ in the horizontal and vertical directions, correction is required. In the example of FIG. 9, the place of the motion vector, for example, (3.5, 1.5) in the normal coordinate system is the place of (2.5, 1) in the downsized coordinate system.

In the position of the motion vector (2.4) in the normal coordinate system is the place of (1.375, 1.875) in the downsized coordinate system. In this case, the position (2,4) at a certain frame number m is the position (1.25, 1.75) by downward rounding in the downsized coordinate system and is the position (1.50, 2.0) by upward rounding at the next frame number m+1. The rounding may be performed for each picture (frame) or for each region to be processed.

By performing rounding to be in the standard of the MPEG-4 and position correction is performed so that a difference due to the rounding processing does not accumulate, a downsized inter picture image of the good image quality can be generated in a simple processing.

The downsized inter picture that is generated at the motion compensation section 28 is kept in the frame buffer section 25 for the next inter picture decoding. As in the intra picture case, the frame buffer section 25 outputs the downsized image to the display device 8 as a result output device.

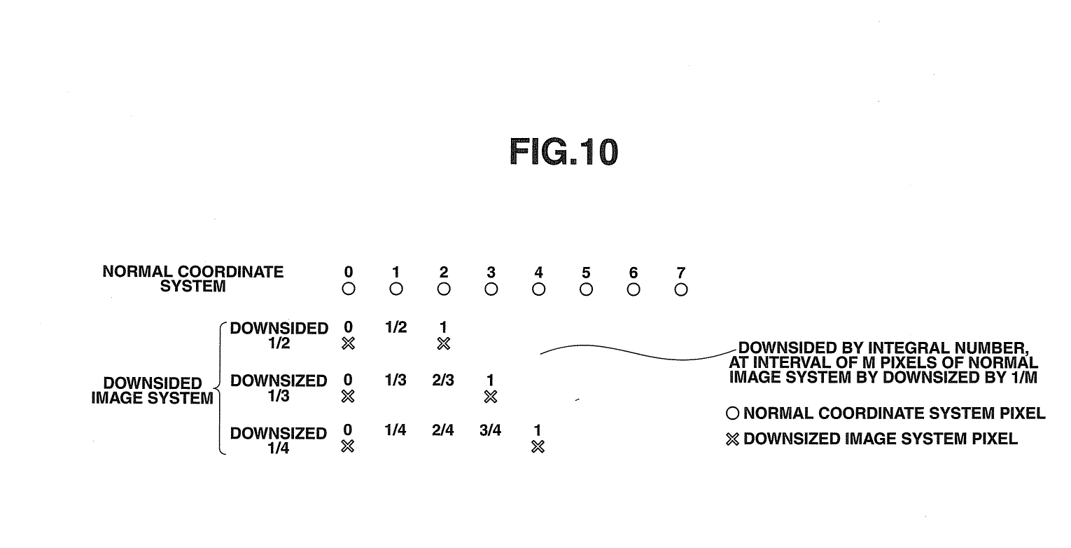

FIG. 10 shows a pixel position when an image is downsized by 1/M. Here, M is a positive integer. If an image is downsized by 1/M, pixels in the normal coordinate system as a coordinate system for the normal image before downsizing are thinned and M-1 pixels are present between the pixels in the downsized coordinate system. In other words, the position 1 in the normal coordinate system is the position 1/M in the downsized coordinate system. The position 3 in the normal coordinate system is 3/M as represented in the downsized coordinate system.

That is represented as Pos″=Pos/M in an expression. Here, Pos is the normal coordinate system and Pos″ is the position in the downsized coordinate system.

FIG. 9 shows a case of ⅜. If it is applied to the case of downsizing an image by 1/M, the origin coordinate (0,0) displaces between the downsized coordinate system after downsizing and the normal image before downsizing. When M is an odd number, the origin coordinate is at an integer position in the normal image coordinate system. When M is an even number, the origin coordinate is at a half Pel position. This is because the center position of the M pixels in the normal image is the downsized image.

Therefore, if an image is downsized by 1/M, the origin coordinate is
Pos′=Pos/M−(M−1)/(2M) (5).

If the downsized image is generated, it is generated for each inverse DCT coefficient. For that purpose, the downsizing scaling factor is restricted to Nx/8, Ny/8. Assuming Nx=Ny=N and N′/8 is substituted for M of the above expression (5), it is represented as the expression below.
Pos′=N′·Pos/8−(8−N′)/16 (6)

As described above, the present embodiment can perform the processing of generating a downsized image in a short time with a simple processing in a less throughput as in the first embodiment, while preventing an aliasing noise from being mixed in the downsized image.

If a motion vector is downsized, the present embodiment can generate the downsized image of the inter picture with good image quality, in which the motion vector position before downsizing is accurately approximated, in a simple processing.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A moving picture decoding device comprising:
a decoding section configured to decode against coding on image data that is coded after an orthogonal transform processing on pixel number blocks that are the image data forming each screen of moving picture divided into a predetermined number N in horizontal and vertical directions by using N×N two dimensional orthogonal transform bases with space frequencies that are different from each other for said predetermined N in the horizontal and vertical directions;
a decoded data generating section configured to generate Nx×Ny pieces of decoded data that is to be at a lower frequency side from a direct current component in the decoded data obtained by said decoding in association with downsizing scaling factors Nx/N, Ny/N in the horizontal and vertical directions (Nx and Ny are natural numbers less than N except 1, respectively);
an inverse orthogonal transforming section configured to perform decoding by inverse orthogonal transform processing on Nx×Ny pieces of decoded data generated by said decoded data generating section by using Nx×Ny two dimensional inverse orthogonal transform bases corresponding to the lower frequency side; and
a position correction section configured to perform position correction on a motion vector that represents a relative position of difference image data if downsized image data obtained by said inverse orthogonal transform processing is difference image data corresponding to a downsized amount of difference obtained at a different time.

2. The moving picture decoding device according to claim 1, wherein said position correction section performs position correction on said motion vector that is generated by downsizing a motion vector before downsizing by said downsizing scaling factor Nx/N, Ny/N, said motion vector before downsizing representing a relative position in said difference image data before downsizing, by further shifting said motion vector in the horizontal and vertical directions by values corresponding to said downsizing scaling factors Nx/N, Ny/N.

3. The moving picture decoding device according to claim 1, wherein
rounding processing is performed on the position data of the motion vector that is subjected to the position correction by said position correction section so as to approximate the position data to data in a predetermined standard.

4. The moving picture decoding device according to claim 3, wherein
said rounding processing sets said position data to data that can be processed in a predetermined standard with a ¼ pixel being the minimum unit.

5. The moving picture decoding device according to claim 3, wherein
said rounding processing changes rounding up and rounding down in approximating for each region to be processed including the case for each frame, or for each time.

6. The moving picture decoding device according to claim 1, wherein
said inverse orthogonal transform base used by said inverse orthogonal transforming section is an inverse discrete cosine conversion base.

7. The moving picture decoding device according to claim 1, wherein
said inverse orthogonal transforming section further performs scale correction when the inverse orthogonal transform processing is performed in association with said downsizing scaling factors Nx/N, Ny/N.

8. The moving picture decoding device according to claim 1, comprising:
a display device configured to display a downsized image that is generated by position correction being performed by said position correction section.

9. The moving picture decoding device according to claim 1, wherein
said inverse orthogonal transforming section performs two dimensional inverse orthogonal transform processing on said Nx×Ny pieces of decoded data that are selected from the low frequency side in order according to the downsizing scaling factor by using said Nx×Ny inverse orthogonal transform bases selected from the low frequency side in order according to the downsizing scaling factor.

10. The moving picture decoding device according to claim 1, wherein
in the case where said predetermined number N=8 and said downsizing scaling factor Nx/N=Ny/N=½, said inverse orthogonal transforming section performs two dimensional inverse orthogonal transform processing on 4×4 pieces of two dimensional decoding data that are selected from those at the lowest frequency including the direct current components in the horizontal and vertical directions in order by using 4×4 inverse discrete cosine conversion bases that are selected from those at the lowest frequency including the direct current components in the horizontal and vertical directions in order.

11. The moving picture decoding device according to claim 1, wherein
said inverse orthogonal transforming section generates downsized image data that also has a function of removing an aliasing noise by the inverse orthogonal transform processing on said Nx×Ny pieces of decoding data by using Nx×Ny two dimensional inverse orthogonal transform bases corresponding to the low frequency side.

12. A moving picture generating device comprising:
a coding section configured to generate coded image data after subjected to orthogonal transform processing on pixel number blocks that are image data forming each screen of moving picture divided into a predetermined number N in horizontal and vertical directions by using N×N two dimensional orthogonal transform bases with space frequencies that are different from each other for the number of said predetermined number N in the horizontal and vertical directions;
a decoding section configured to perform decoding against said coding on said coded image data;
a decoded data generating section configured to generate Nx×Ny pieces of decoded data that are to be at a lower frequency side from a direct current component in the decoded data obtained by said decoding in association with downsizing scaling factors Nx/N, Ny/N in the horizontal and vertical directions (Nx and Ny are natural numbers less than N except 1, respectively);
an inverse orthogonal transforming section configured to perform decoding by inverse orthogonal transform processing on Nx×Ny pieces of decoded data generated by said decoded data generating section by using Nx×Ny pieces of two dimensional inverse orthogonal transform bases corresponding to the lower frequency side; and
a position correction section configured to perform position correction on a motion vector that represents a relative position of difference image data, if downsized image data obtained by said inverse orthogonal transform processing is the difference image data corresponding to a downsized amount of difference obtained at different time.

13. The moving picture generating device according to claim 12, wherein said position correction section performs position correction on said motion vector that is generated by downsizing a motion vector before downsizing by said downsizing scaling factor Nx/N, Ny/N, said motion vector before downsizing representing a relative position in said difference image data before downsizing, by further shifting said motion vector in the horizontal and vertical directions by values corresponding to said downsizing scaling factors Nx/N, Ny/N.

14. The moving picture generating device according to claim 12, wherein
rounding processing is performed on the position data of the motion vector that is subjected to the position correction by said position correction section so as to approximate the position data to data in a predetermined standard.

15. The moving picture generating device according to claim 14, wherein
said rounding processing sets said position data to data that can be processed in a predetermined standard with a ¼ pixel being the minimum unit.

16. The moving picture generating device according to claim 14, wherein
said rounding processing changes rounding up and rounding down in approximating for each region to be processed including the case for each frame, or for each time.

17. The moving picture generating device according to claim 12, wherein
said inverse orthogonal transform base used by said inverse orthogonal transforming section is an inverse discrete cosine conversion base.

18. The moving picture generating device according to claim 12, wherein
said inverse orthogonal transforming section further performs scale correction when the inverse orthogonal transform processing is performed in association with said downsizing scaling factors Nx/N, Ny/N.

19. The moving picture generating device according to claim 12, comprising:
a display device configured to display a downsized image that is generated by position correction being performed by said position correction section.

20. The moving picture generating device according to claim 12, wherein
said inverse orthogonal transforming section performs two dimensional orthogonal transform processing on said Nx×Ny pieces of decoded data that are selected from the low frequency side in order according to the downsizing scaling factor by using said Nx×Ny inverse orthogonal transform bases selected from the low frequency side in order according to the downsizing scaling factor.
